(19) United States
(12) Patent Application Publication
(10) Pub. No.: US 2010/0170669 A1
(43) Pub. Date: Jul. 8, 2010

(54) ALUMINUM HEAT EXCHANGER WITH PIT RESISTANT BRAZE JOINTS

(75) Inventor: Mark R. Jaworowski, Glastonbury, CT (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: Carrier Corporation, Farmington, CT (US)

(21) Appl. No.: 12/664,586

(22) PCT Filed: Jun. 26, 2007
(86) PCT No.: PCT/US07/14820

§ 371 Date: Dec. 14, 2009

(51) Int. Cl. F28F 9/02; B23K 31/02; C22C 21/04; C22C 21/08

(52) U.S. Cl. 165/173; 228/199; 420/549; 420/546

(57) ABSTRACT

An aluminum braze alloy suitable for use in brazing aluminum alloy components for heat exchanger's which includes lesser amounts of silicon, and further including at least one of magnesium, calcium, a lanthanide series metal and mixtures thereof in a concentration sufficient to form a passivating film under corrosive conditions.

### FIELD OF THE INVENTION

This invention relates generally to heat exchangers and more specifically to a system for making pit resistant braze joints for heat exchangers.

### BACKGROUND OF THE INVENTION

In conventional minicharmel heat exchangers, refrigerant flows through an inlet opening and into the internal cavity of an inlet manifold. From the inlet manifold, the refrigerant, in a single-pass configuration, enters and passes through a series of parallel heat transfer tubes to the internal cavity of an outlet manifold. Externally to the tubes, air is circulated over the heat exchange tubes and associated airside fins by an air-moving device such as fan, so that heat transfer interaction occurs between the air flowing outside the heat transfer tubes and refrigerant inside the tubes. The heat exchange tubes can be hollow or have internal enhancements such as ribs for structural rigidity and heat transfer augmentation. The heat transfer tubes can be of any cross-section, but preferably are either predominantly rectangular or oval.

The heat exchanger elements are usually made from aluminum (aluminum alloy) and attached to each other during furnace brazing operations using an aluminum/silicon braze alloy. These heat exchangers have been observed to exhibit a sequential corrosion process involving crevice corrosion at the tube/header braze joint, and pitting of the tube at the mouth of the crevice that results in loss of pressure integrity. These pits are believed to be catalyzed by local cathodic reactions. In order to solve these corrosion problems, organic coatings which require additional manufacturing steps have been used. These coatings however are prone to exhibiting defects. Chromate conversion coatings are another alternative, but these treatments involve hazardous chromate compounds that are intensely regulated for health reasons.

U.S. Pat. No. 4,929,511 teaches a low temperature aluminum based brazing alloy which may contain magnesium in concentrations up to 3.0%. U.S. Pat. No. 6,610,247 teaches an aluminum brazing alloy which may contain up to 0.1% magnesium.

### SUMMARY OF THE INVENTION

Exemplary embodiments of the invention include a braze alloy suitable for use in brazing aluminum alloy components for heat exchangers. The braze alloy includes aluminum and lesser amounts of silicon and further includes at least one additive of magnesium, calcium, and a lanthanide series metal and mixtures thereof, and the at least one additive is at a concentration sufficient to form a passivating film of precipitates under corrosive conditions. Exemplary embodiments further include a method of making pit resistant braze joints on an aluminum heat exchanger. The method includes brazing a joint formed by at least two aluminum alloy components with an aluminum braze alloy and applying a slurry including at least one of magnesium, calcium, and a lanthanide series metal and mixtures thereof to the braze joint to form a coating thereon. The method further includes allowing the coating to dry, the coating functions to form a passivating coating on the braze joint under corrosive conditions.

Exemplary embodiments further include an aluminum alloy heat exchanger including a plurality of tubes and manifolds interconnected to form an enclosed flow path with the interconnections being sealed with an aluminum base braze alloy with the braze alloy further including at least one of magnesium, calcium, and a lanthanide series metal and mixtures thereof in an amount sufficient to form a passivating film under corrosive conditions.

### BRIEF DESCRIPTION OF THE DRAWINGS

FIG. 1 is a front elevation view of a minichannel aluminum heat exchanger

FIG. 2 is a partial enlarged perspective view of the heat exchanger of FIG. 1 at a tube header braze joint.

FIG. 3 is a vertical sectional view along line 3-3 of FIG. 2 illustrating crevice corrosion adjacent to a pinhole.

FIG. 4 is a plot of voltage vs. pH illustrating the effect of magnesium in a braze joint under corrosive conditions.

FIG. 5 is a plot of voltage vs. pH illustrating the effect of calcium in a braze joint under corrosive conditions.

### DETAILED DESCRIPTION OF THE INVENTION

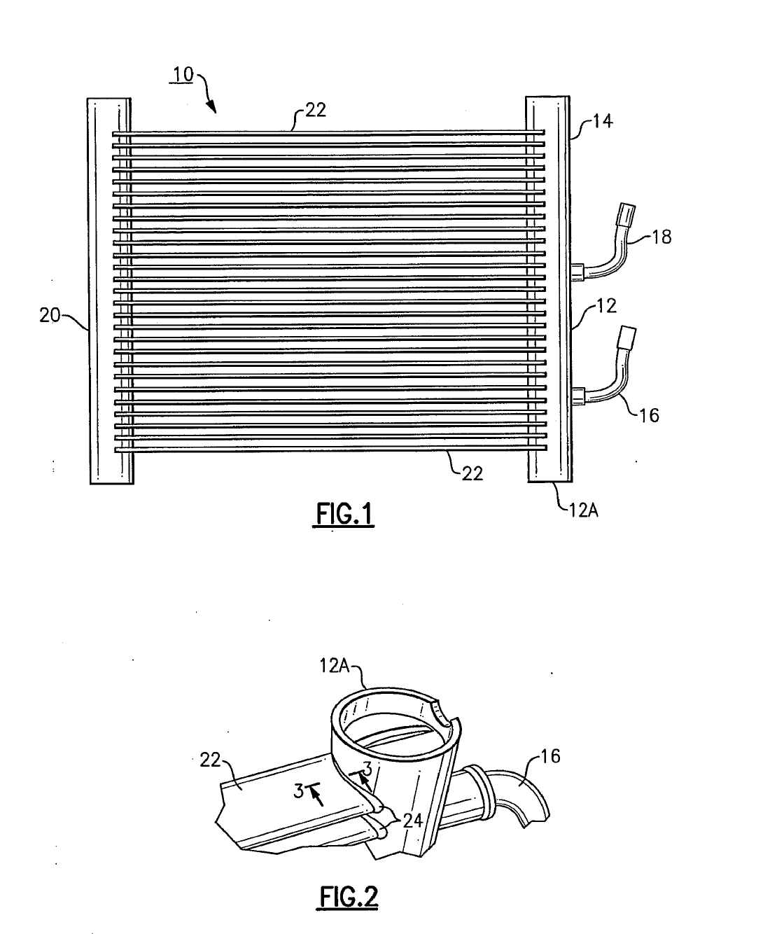

Referring now to FIG. 1, in one embodiment of the invention, a minichannel parallel flow heat exchanger 10 is shown to include an inlet header or manifold 12, and adjoining outlet header or manifold 14, and a plurality of parallel disposed heat exchange tubes 22 fluidly interconnecting the inlet manifold and the outlet manifold with an intermediate manifold 20 disposed on an opposite side of heat exchanger 10. Typically, the inlet and outlet manifolds 12 and 14 are circular or rectangular in cross-section, and the heat exchange tubes 22 are tubes (or extrusions) of flattened or round shape. The heat exchange tubes 22 normally have a plurality of internal and external heat transfer enhancement elements, such as fins (not shown). For example, external fins (not shown) can be uniformly disposed therebetween for the enhancement of the heat exchange process and structural rigidity, and are typically furnace-brazed. The heat transfer tubes 22 may also have internal heat transfer enhancements and structural elements dividing each tube into multiple channels along which the refrigerant is flowed in a parallel manner. A refrigerant line 16 delivers refrigerant to manifold 12, with refrigerant flowing out of manifold 14 through line 18.

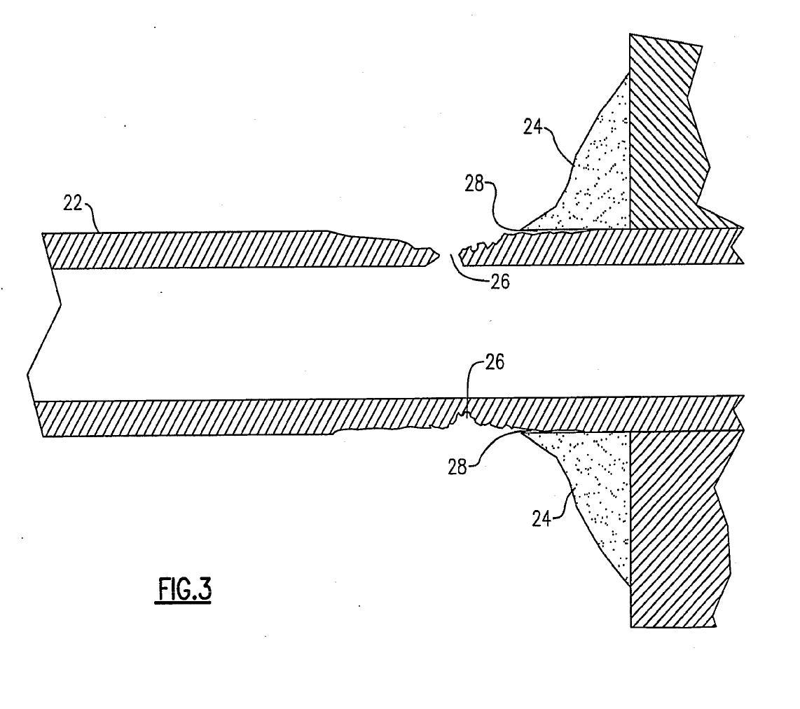

A baseline MCHX coil of the type shown in FIG. 1 fabricated from zinc coated 3102 aluminum alloy was subjected to cyclic salt spray testing for 4200 hours. A leak was detected at a tube/header braze joint at the location along line 3-3 in FIG. 2. The leak was identified as a pinhole 26 as shown in FIG. 3. In cross-section, the leak was shown to be a pinhole 26 in the tube adjacent to the braze joint 24 in the header 12A. The header/tube bond line was also observed to have undergone crevice corrosion at 28 adjacent to the pit that caused the leak, as shown in FIG. 3 which is a cross section view taken along line 3-3 of FIG. 2.

Crevice corrosion is understood to proceed by an oxygen concentration gradient that develops between the aerated “mouth” of the crevice and the oxygen-deprived regions of the crevice interior. This dissolved oxygen gradient is maintained by the reaction of dissolved oxygen with electrons generated by the corrosion of metal in the crevice region as:

O₂+2 H₂O+4 e⁻→4 OH⁻.

The hydroxyl ion product of this reaction creates a zone of intense alkalinity in the aerated region near the crevice mouth. This alkalinity is believed to contribute to the pitting failure of the aluminum tube near the crevice mouth.

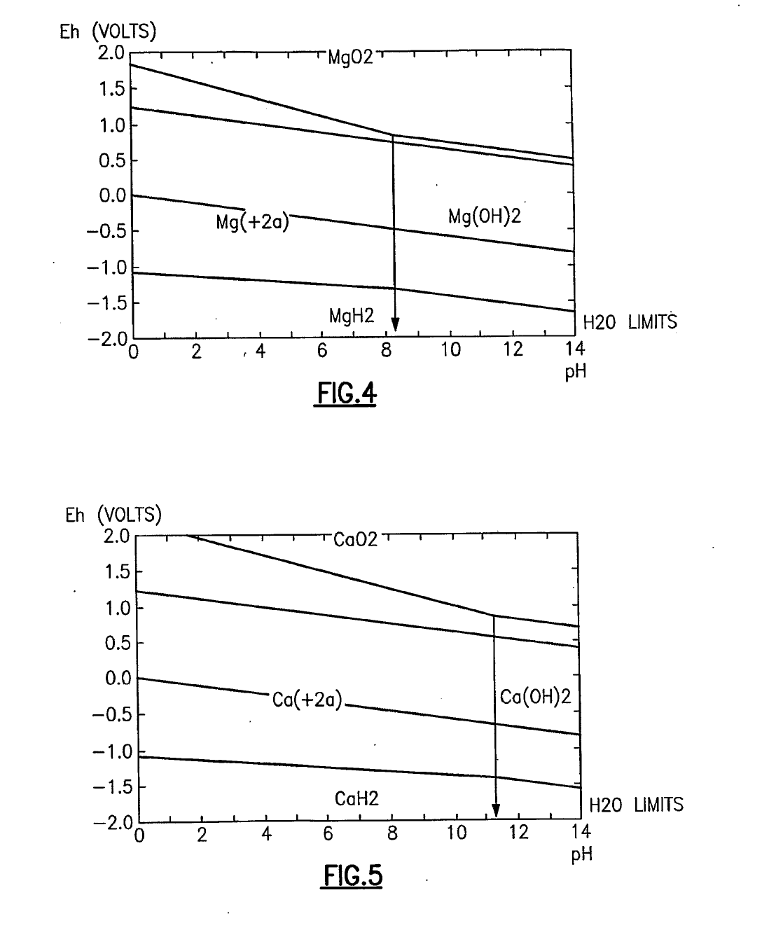

In one embodiment of the invention, a MCHX coil is brazed using a braze alloy containing greater than 0.1%, preferably 1-2%, magnesium (Mg), calcium (Ca) or magnesium/calcium combined. Under corrosive conditions, a passivating film of Mg(OH)₂ or Ca(OH)₂ precipitates in the alkaline region near the crevice mouth, arresting the progress of pitting and crevice corrosion. Aluminum alloys are know to corrode rapidly at pH values above 11.5. FIG. 4 is a stability diagram for Mg and H₂O and shows that at a pH of 8.3, Mg(OH)₂ will precipitate, buffering the local pH and forming a passivating film which arrests the progress of corrosion. Similarly, as shown in FIG. 5 for Ca, a pH of 11.2, Ca(OH)₂ will also function as a buffer and precipitate to form a corrosion resistant passivating film.

In a second embodiment of the invention, a MCHX coil is brazed using a braze alloy containing 0.1%-1%, preferably 0.3-7% lanthanum or lanthanide series metal, with cerium preferred. Under corrosive conditions, a passivating film of lanthanum oxide or lanthanum series metal oxide precipitates in the alkaline region near the crevice mouth, arresting the progress of pitting and crevice corrosion.

In a further embodiment of the invention, the Mg and/or Ca or the lanthanides may be applied to the braze joint surface after brazing. In this embodiment, a slurry or aqueous solution of the appropriate element or elements is formed and coated on to the formed braze joint. The coating is then dried and functions to form a passivating film under corrosive conditions. More specifically sealing with Mg(OH)₂ or Ca(OH)₂ can be accomplished by exposing the brazed heat exchanger by immersion or spray to a solution, preferably saturated of Mg(OH)₂ or Ca(OH)₂, at controlled temperature, preferably 130-160° F. for a controlled time, preferably five minutes, followed by an optional but preferred rinse.

A suitable brazing composition for use in the present consists essentially of about 9 to 13 weight percent silicon, 0 to 3 weight percent magnesium, 0 to 4 weight percent copper, 0 to 0.2 weight percent of at least one element selected from the group consisting of bismuth, strontium, lithium, scandium, yttrium, calcium, phosphorous, sodium and 0-2 weight percent of at least one of the rare earth elements, the balance being essentially aluminum and incidental impurities.

A suitable aluminum alloy for the heat exchanger components is AA3102 which has the following composition.

| Component | Wt. % |
|---|---|
| Al | Max 97.8 |
| Cu | Max 0.1 |
| Fe | Max 0.7 |
| Mn | 0.05-0.4 |
| Si | Max 0.4 |
| Ti | Max 0.1 |
| Zn | Max 0.3 |

It should be understood that while the above-described embodiment shows a minichannel heat exchanger, any type of heat exchanger having aluminum tubes can be used. In addition, any type of heat exchanger that uses refrigerant, water, or air is also contemplated.

The present invention extends the life of aluminum alloy heat exchangers by arresting the primary corrosion failure sequence through the formation of a passivating film under corrosive conditions.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A braze alloy suitable for use in brazing aluminum alloy components for heat exchangers comprising aluminum and lesser amounts of silicon and further comprising at least one additive of magnesium, calcium, and a lanthanide series metal and mixtures thereof, wherein the at least one additive is at a concentration sufficient to form a passivating film of precipitates under corrosive conditions.

2. The alloy of claim 1 in which the magnesium is present in an amount greater than 0.1% by weight of said braze alloy.

3. The alloy of claim 1 in which the calcium is present in an amount greater than 0.1% by weight of said braze alloy.

4. The alloy of claim 1 in which the magnesium and calcium are present in an amount of about 1.0 to 2.0 by weight of said braze alloy.

5. The alloy of claim 1 in which the lanthanide series metal is present in an amount greater than 0.1% by weight of said braze alloy.

6. The alloy of claim 1 in which the lanthanide series metal is present in an amount of about 0.1 to 1.0% by weight of said braze alloy.

7. The alloy of claim 1 in which the lanthanide series metal is present in an amount of about 0.3 to 0.7% by weight of said braze alloy.

8. A method of brazing at least one joint formed by a plurality of aluminum alloy components with an aluminum base braze alloy followed by applying at least one of magnesium, calcium, and a lanthanide series metal to said braze joint surface in an amount and at a concentration sufficient to form a passivating film of precipitates under corrosive conditions.

9. A method of making pit resistant braze joints on an aluminum heat exchanger, the method comprising:
brazing a joint formed by at least two aluminum alloy components with an aluminum braze alloy;
applying a slurry comprising at least one of magnesium, calcium, and a lanthanide series metal and mixtures thereof to said braze joint to form a coating thereon; and
allowing said coating to dry, said coating functions to form a passivating coating on said braze joint under corrosive conditions.

10. An aluminum alloy heat exchanger comprising a plurality of tubes and manifolds interconnected to form an enclosed flow path with said interconnections being sealed with an aluminum base braze alloy with said braze alloy further comprising at least one of magnesium, calcium, and a lanthanide series metal and mixtures thereof in an amount sufficient to form a passivating film under corrosive conditions.
